(19) United States
(12) Patent Application Publication
(10) Pub. No.: US 2021/0295234 A1
(43) Pub. Date: Sep. 23, 2021

(54) AUTOMATED EVIDENCE COLLECTION

(71) Applicant: Shujinko Inc., Seattle, WA (US)

(72) Inventors: MATTHEW WELLS, Preston, WA (US); SCOTT SCHWAN, Seattle, WA (US); JEFFREY ROBERTS, Hayward, CA (US)

(73) Assignee: Shujinko Inc., Seattle, WA (US)

(21) Appl. No.: 17/064,425

(22) Filed: Oct. 6, 2020

Related U.S. Application Data
(60) Provisional application No. 62/993,657, filed on Mar. 23, 2020.

(51) Int. Cl. G06Q 10/06; G06F 9/54

(52) U.S. Cl. CPC G06Q 10/06395; G06F 9/547

(57) ABSTRACT

Techniques are provided for automated evidence collection. A first standard is processed to generate first collection instructions that, when executed, obtain evidence data corresponding to a first plurality of evidence types from cloud environments deployed at a cloud service provider system. A request is received to perform an audit operation, related to the first standard and a first cloud environment deployed at the cloud service provider system. First selected instructions are determined that are associated with at least one evidence type associated with the audit operation. The first selected instructions are executed to obtain first evidence data on the first cloud environment from the cloud service provider system. An audit result is determined based on the first evidence data.

### CROSS-REFERENCE TO RELATED APPLICATIONS; BENEFIT CLAIM

This application claims the benefit of Provisional Application Ser. No. 62/993,657, filed Mar. 23, 2020, the entire contents of which are hereby incorporated by reference as if fully set forth herein, under 35 U.S.C. § 119(e). This application is also related to copending U.S. patent application Ser. No. 17/064,381, filed Oct. 6, 2020, the entire contents of which are hereby incorporated by reference as if fully set forth herein.

### FIELD OF THE DISCLOSURE

The present disclosure generally relates to enterprise data and systems, and relates more specifically to automated evidence collection for verifying compliance with one or more standards.

### BACKGROUND

There are many reasons that an organization may implement a standard. For example, an organization may engage in business in a regulated industry that requires a particular standard to be met. An organization may also implement a standard that describes best practices for various reasons, such as to mitigate the risk of a data breach or another potentially costly failure. In some cases, a vendor's customers may prefer or require verification that the vendor satisfies a particular standard. An audit is a process that is performed to evaluate an entity's compliance with a standard.

Compliance and auditing may involve highly complex, time-consuming, and costly processes, especially when a larger organization implements a complex standard. For example, the organization may need to assess its operation, identify necessary changes, and implement the changes in areas such as technology, infrastructure, operations, employment, practices, policies, procedures, and the like. An organization may also need to ensure that compliance with the standard is achieved and maintained. Furthermore, a standard may be updated periodically. When a standard is updated, the organization must become aware of changes to the standard and take action to implement the changes.

The approaches described in this section are approaches that could be pursued, but are not necessarily approaches that have been previously conceived or pursued. Therefore, unless otherwise indicated, it should not be assumed that any of the approaches described in this section qualify as prior art merely by virtue of their inclusion in this section.

### SUMMARY

The appended claims may serve as a summary of the invention.

### BRIEF DESCRIPTION OF THE DRAWINGS

In the drawings:

FIG. 1 illustrates a computer system for automated evidence collection in an example embodiment;

FIG. 2 illustrates instructions in a data model for automated evidence collection in an example embodiment;

FIG. 3 illustrates relationships between standard objects, control objects, and evidence objects in a system for automated evidence collection in an example embodiment;

FIG. 4A illustrates an example evidence collection module executing collection instructions in an example embodiment;

FIG. 4B illustrates example control data in an example embodiment;

FIG. 5 is a flow diagram of a process for automated evidence collection in an example embodiment;

FIG. 6 illustrates a computer system upon which an embodiment may be implemented.

While each of the drawing figures illustrates a particular embodiment for purposes of illustrating a clear example, other embodiments may omit, add to, reorder, or modify any of the elements shown in the drawing figures. For purposes of illustrating clear examples, one or more figures may be described with reference to one or more other figures, but using the particular arrangement illustrated in the one or more other figures is not required in other embodiments.

### DETAILED DESCRIPTION

In the following description, for the purpose of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

It will be further understood that: the term “or” may be inclusive or exclusive unless expressly stated otherwise; the term “set” may comprise zero, one, or two or more elements; the terms “first”, “second”, “certain”, and “particular” are used as naming conventions to distinguish elements from each other, and do not imply an ordering, timing, or any other characteristic of the referenced items unless otherwise specified; the term “and/or” as used herein encompasses any and all possible combinations of one or more of the associated listed items; that the terms “comprises” and/or “comprising” specify the presence of stated features, but do not preclude the presence or addition of one or more other features.

A “computer” may include one or more physical computers, virtual computers, and/or computing devices. For example, a computer may be, or may comprise, one or more server computers, cloud-based computers, cloud-based cluster of computers, virtual machine instances or virtual machine computing elements such as virtual processors, storage and memory, data centers, storage devices, desktop computers, laptop computers, mobile devices, and/or any other special-purpose computing devices. Any reference to “a computer” herein may mean one or more computers, unless expressly stated otherwise.

A “system” (such as but not limited to compliance server system 110, customer computer system 140, and cloud service provider system 120) may include one or more computers, such as physical computers, virtual computers, and/or computing devices. For example, a system may be, or may comprise, one or more server computers, cloud-based computers, cloud-based cluster of computers, virtual machine instances and/or virtual machine computing elements such as virtual processors, storage and memory, data centers, storage devices, desktop computers, laptop computers, mobile devices, and/or any other special-purpose computing devices. A system may include another system, and computers may belong to two or more systems.

A “module” may be one or more hardware components and/or software stored in, or coupled to, a memory and/or one or more processors on one or more computers. Additionally and/or alternatively, a module may comprise specialized circuitry. For example, a module, such as but not limited to standard processing module 102, construction module 104, and evidence collection module 106, may be hardwired or persistently programmed to support a set of instructions to, and/or that are useful to, perform the functions discussed herein.

As used herein, the term “database” refers to one or more data stores for at least one set of data. The data store may include one or more tangible and/or virtual data storage locations, which may or may not be physically co-located. A simple example of a database is a text file used to store information about a set of data. Another example of a database is one or more data stores that are maintained by a server. Clients may access the database by submitting requests to the server that cause the database server to perform operations on the database. In some embodiments, the server is a server in a database management system (DBMS).

A “server” may include a combination of integrated software components and an allocation of computational resources, such as memory, a computing device, and/or processes on the computing device for executing the integrated software components. The combination of the software and computational resources are dedicated to providing a particular type of function on behalf of clients of the server. A server may refer to either the combination of components on one or more computing devices, or the one or more computing devices (also referred to as “server system”). A server system may include multiple servers; that is, a server system may include a first server and a second server, which may provide the same or different functionality to the same or different set of clients.

A “client” may include a combination of integrated software components and an allocation of computational resources, such as memory, a computing device, and/or processes on a computing device for executing the integrated software components. The combination of the software and computational resources are configured to interact with one or more servers over a network, such as the Internet. A client may refer to either the combination of components on one or more computers, or the one or more computers (also referred to as “client computing devices”).

### General Overview

This document generally describes systems, methods, devices, and other techniques for automated evidence collection. In general, a compliance server system may automate the collection of evidence data, such as evidence data required for an audit. For example, a customer may submit an audit request to the compliance server system. In response to the audit request, the compliance server system performs processes to collect evidence that supports a finding of whether one or more systems are compliant with a standard. For example, the compliance server system may collect evidence relating to the Service Organization Control 2 (SOC 2) standard. SOC 2 includes criteria for organizational controls related to security, and optionally availability, processing integrity, confidentiality, and/or privacy.

The compliance server system may execute collection instructions to obtain evidence data from cloud environments controlled by a customer. In some embodiments, a standard is processed to generate control objects associated with the standard, and collection instructions are generated for automatically obtaining evidence data associated with the control objects. When the collection instructions are executed, the respective evidence data is collected programmatically, such as by executing collection instructions associated with the respective collection objects.

Evidence collection may be performed to determine a system's compliance at a particular time and/or to determine compliance over a period of time. In some embodiments, a compliance server system accesses one or more customer environments and provides compliance data to the corresponding customer. The customer may use the compliance data to manage its operations.

In some embodiments, the compliance server system accesses one or more customer environments to generate a compliance report. For example, the compliance server system may generate one or more portions of a compliance report that describes an entity's compliance with a particular standard. Alternatively and/or in addition, the compliance server system may present evidence data related to an audit. In some embodiments, the compliance server system provides an auditor interface to present a compliance report and/or relevant evidence data to a third party, such as an auditor.

In some embodiments, the compliance server system streamlines the collection of evidence data that is not collected programmatically. For example, the compliance server system may provide a compliance interface that allows one or more users to assign evidence collection tasks, communicate about tasks or evidence data, upload evidence data, review evidence data, annotate evidence data, configure evidence collection parameters, and/or otherwise manage evidence collection through a centralized compliance interface.

In some implementations, the various techniques described herein may achieve one or more of the following advantages: an organization may ensure compliance with one or more standards with greatly reduced time, effort, and other overhead; an audit of an organization may be performed with greatly reduced time, effort, and other overhead; an organization may efficiently scale compliance management across one or more cloud environments; a compliance provider operating a compliance server system may streamline audit operations; an organization may implement one or more standards in a cloud architecture with greatly reduced time, effort, and other overhead; and/or presentation of evidence data related to an audit may be facilitated. Additional features and advantages are apparent from the specification and the drawings.

### System Overview

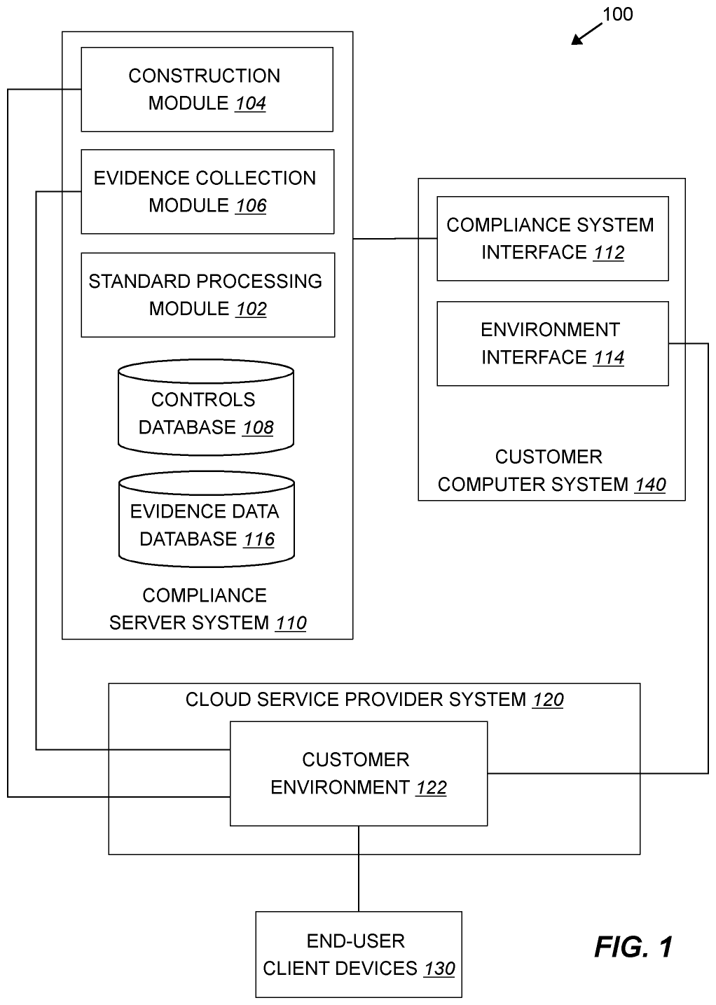

FIG. 1 illustrates a computer system for automated evidence collection in an example embodiment. The computer system 100 includes a compliance server system 110, a customer computer system 140, a cloud service provider system 120, and one or more end-user client devices 130. The compliance server system 110, customer computer system 140, cloud service provider system 120, and end-user client device/s 130 communicate over one or more networks. The network/s may include one or more local area networks (LANs) and/or one or more wide area networks, such as the Internet.

The compliance server system 110 is configured to perform operations relating to a customer's compliance with one or standards. In some embodiments, the compliance server system 110 includes an evidence collection module 106. The evidence collection module 106 collects evidence data from one or more computer systems owned and/or controlled by the customer/s. In some embodiments, the evidence collection module 106 automates evidence collection by executing collection instructions to programmatically collect evidence data.

In some embodiments, the evidence collection module 106 may collect evidence data from a customer environment 122 deployed at a cloud service provider system 120 on behalf of a customer. The customer has control over the customer environment 122. For example, the customer may own and/or control a customer computer system 140 from which agents of the customer operate the customer environment 122 as a live production environment that makes a service and/or application available to end-user client devices 130.

In some embodiments, the compliance server system 110 is configured to generate environments that comply with a selected standard. The compliance server system 110 may include a construction module 104. In some embodiments, the standard processing module 102 generates construction instructions for automatically creating generated environments that satisfy one or more controls associated with a standard. The construction module 104 may execute the construction instructions associated with the controls to create generated environments that are compliant with the standard. Provisioning a compliant environment is described in greater detail in U.S. patent application Ser. No. 17/064,381, filed on Oct. 6, 2020, the entire contents of which are hereby incorporated by reference as if fully set forth herein.

The compliance server system 110 and/or its components (e.g. standard processing module 102, construction module 104, evidence collection module 106, controls database 108, and/or evidence database 116) as described herein are presented as individual components for ease of explanation; any action involving (e.g. performed by or to) one or more components of the compliance server system 110 may be considered performed with respect to (e.g. performed by or to) the compliance server system 110. The compliance server system 110 and/or its components may be implemented as one or more dependent or independent processes, and may be implemented on one or multiple computers; for example, a component may be implemented as a distributed system. Alternatively and/or in addition, multiple instances of the compliance server system 110 and/or one or more components thereof may be implemented. Furthermore, a component shown may be implemented fully and/or partially in one or more programs or processes, and two or more components shown may be implemented fully and/or partially in one program and/or process.

### Customer Environment

As used herein, the term “environment” refers to a set of resources, including but not limited to virtualized resources, that are necessary to execute an application and/or service. For example, in a cloud platform managed by a cloud service provider, an environment may include the set of resources necessary to execute the application and/or service within the cloud platform. A cloud service provider may provide other parties with a cloud-based platform that supports the deployment of cloud environments, such as but not limited to virtual machines, containers, and the like.

An environment may refer to one instance or multiple instances of a virtual machine, container, etc. with an identical purpose and/or configuration, referred to herein as duplicate instances. When an environment includes duplicate instances, the compliance server system 110 may perform one or more actions described herein on each duplicate instance to ensure that the individual instances and the collection of duplicate instances are all compliant with one or more standards.

While one customer computer system 140, one customer environment 122, and one cloud service provider system 120 are shown, the compliance server system 110 may provide services relating to environments for one or multiple customer server systems 140; the compliance server system 110 may collect evidence data from one or multiple customer environments 122 on a cloud service provider system 120; and/or the compliance server system 110 may collect evidence data from customer environments 122 on one or multiple cloud service provider systems 120.

### Standards

The compliance server system 110 may implement one or more standards, such as SOC 2, Health Insurance Portability and Accountability Act (HIPAA), General Data Protection Regulation (GDPR), Payment Card Industry Data Security Standard (PCI DSS), Federal Information Security Management Act (FISMA), and/or other standards. As used herein, the term “standard” refers to a set of requirements, obligations, criteria, recommendations, guidelines, procedures, and the like, referred to hereinafter as “a set of one or more rules.” A standard may be published by a government organization, such as in a law or regulation. A standard may also be published by an organization, such as an industry organization, customer organization, or another body. A standard may also be described by one or more private parties. For example, a customer may define a particular set of rules to implement within its organization. As another example, the terms of a contract or other agreement may include a set of rules that one party wishes to implement.

A standard may include rules on various topics, such as performing background checks, implementing or testing a disaster recovery policy, requiring passwords on computer systems, software updates and patches, handling sensitive data and/or personally identifiable information (PII), security and privacy documentation, preventing unauthorized access, system availability, system redundancy, documentation of incidents, computer system configurations including software, hardware, and/or network configuration, and other rules.

### Control Data

In some embodiments, the compliance server system 110 includes a standard processing module 102. The standard processing module 102 may process one or more standards to generate control data that describes a plurality of controls. A control is associated with a standard, and may relate to a particular rule within the standard.

The compliance server system 110 can implement a control by generating control data that models the control in a manner that is usable by the compliance server system 110. After the standard processing module 102 processes a standard, the evidence collection module 106 may use the control data to collect evidence data from one or more customer environments 122 at one or more points in the future. For example, if a standard includes a control comprising a versioning rule that requires software packages to be updated, the standard processing module 102 may generate control data that describes the versioning rule and collection instructions for obtaining version information for one or more particular software packages that are installed in a customer environment 122.

The evidence collection module 106 executes collection instructions related to the versioning rule to obtain evidence data from one or more customer environments 122 relating to the software package versions. The control is satisfied if the obtained evidence data supports a finding that the particular software packages are updated.

After processing the standard to generate control data corresponding to the standard, the compliance server system 110 may store control data in a controls database 108. The controls database 108 may make the control data available to other components of the compliance server system 110, such as the construction module 104 and the evidence collection module 106.

The compliance server system 110 uses the control data to automate evidence collection. In some embodiments, the evidence collection module 106 uses the control data to perform an audit of cloud environments (e.g. customer environment 122). For example, the control data may include collection instructions that, when executed, collects evidence data from one or more customer environments. Collection instructions are described in greater detail hereinafter.

In some embodiments, the standard processing module 102 may generate control data by processing a standard with input from an administrative user. For example, the administrative user may generate the control data for a standard by data entry and/or programmatic methods. In some embodiments, the administrative user uses a standard processing interface of the standard processing module 102 to process the standard and generate the control data. In some embodiments, the standard processing module 102 may automatically process at least a portion of a standard to identify one or more controls. For example, the standard may be processed in a plain-text form, an eXtensible Markup Langauge (XML) form, another markup language form, or another digital form. In some embodiments, after automatically identifying a control, the standard processing module 102 presents the control to an administrative user in a standard processing interface for confirmation and/or additional configuration.

In some embodiments, the standard processing module 102 generates control data that is specific to a particular cloud service provider system 120. For example, the compliance server system 110 may generate control data to implement controls related to one or more Amazon Web Services (AWS) features, such as but not limited to:
API Gateway—AWS service for managing REST and WebSocket APIs at scale
Aurora Relational Database Service (RDS)AWS relational database compatible with MySQL and InnoDB storage engine
Bastion Host—Hardened host that sits behind the VPN and acts as an SSH proxy for services within your VPC
Certificate Manager (ACM)AWS certificate service for provisioning, managing, and deploying public and private SSL/TLS certificates
CIS Hardening for AWS Accounts—Automatically apply CIS Benchmark recommended settings to your AWS account
CloudFront—AWS content delivery network service that helps increase your edge presence globally
DynamoDB NoSQL Service—AWS proprietary NoSQL database for key-value and document data structures
EC2 Instance DataDog Integration—Installs the DataDog Agent on EC2 instances
EC2 Instance Falco Integration—Installs the Falco agent on EC2 instances
EC2 Instance Splunk Integration—Installs a fluentd log shipper for integrating with Splunk on EC2 instances
EC2 Instance Wazuh Integration—Installs the Wazuh agent on EC2 instances
EC2 Load Balancer Service—Distribute incoming application traffic across multiple targets within your AWS environment
Elastic Container Registry—AWS Docker container registry
Elastic Container Service (ECS)AWS container orchestration service for Docker containers
Elasticache Memcached—AWS in-memory data store and cache service for Memcached
Elasticache Redis—AWS in-memory data store and cache service for Redis
ElasticSearchAWS ElasticSearch service
InspectorAWS automated security assessment scanner for evaluating application exposure, vulnerabilities, and deviations from best practices on AWS
Key Management Service—AWS managed encryption key service
Lambda—AWS event driven, serverless computing platform
Managed Message Broker (ActiveMQ)Amazon MQ is a managed message broker service for Apache ActiveMQ
OpenVPN—Create a secure point to point connection to your VPC
Route 53 DNS Service—AWS scalable and highly available Domain Name Service
Secrets Manager—AWS service that helps enable rotation, management, and retrieval of secrets throughout their lifecycle
Simple Email Service (SES)AWS email sending service
Simple Notification Service (SNS)AWS solution for mass delivery of messages
Simple Queue Service (SQS)AWS distributed message queueing service
Simple Storage Service (S3)AWS scalable object storage solution
Systems Manager (SSM) Parameter Store—AWS secrets management and configuration data management service
Systems Manager (SSM) Session Manager—AWS service for creating shell-level access within EC2 instances using a secure interface without SSH
Transfer Server (SFTP)AWS SFTP service using S3 as the backend
Virtual Private Cloud—Provision a logically isolated section of the AWS Cloud where you can launch AWS resources in a virtual network that you define
Web Application Firewall—AWS web application firewall service that helps protect web applications from common web exploits

The compliance server system 110 may generate control data to implement controls related to one features provided by Amazon Web Services (AWS), Microsoft Azure, Google Cloud Platform (GCP), other public cloud operating systems, native and third party software services usable in one or more cloud environments, and/or any other similar software related to a customer environment 122. In some embodiments, the control data includes collection instructions that, when executed, obtains evidence data from any digital source, including but not limited to public cloud operating systems and/or software executed within such public cloud operating systems.

In some embodiments, the standard processing module 102 updates control data corresponding to a standard when updates are made to the standard. The compliance server system 110 may also update control data when one or more changes are made to one or more cloud environments and/or related software. For example, when an Application Programming Interface (API) changes, the compliance server system 110 may update any control data affected by the API changes.

The compliance server system 110 may be configured to handle multiple standards. For example, the standard processing module 102 may process a plurality of standards to generate control data corresponding to a plurality of controls. The control data stored in the controls database 108 is associated with one or more of the standards. The compliance server system 110 may receive a request to audit a customer with respect to one or more selected standards handled by the compliance server system 110. In response to the request, the evidence collection module 106 may select a relevant set of control data corresponding to relevant controls that are associated with the selected standard/s.

### Evidence

In some embodiments, the evidence collection module 106 communicates with the cloud service provider system 120 and/or the customer computer system 140 to collect evidence data corresponding to a control. As used herein, the term “evidence type” refers to a data type that is required to verify whether an associated control is satisfied. The term “evidence data” is used to refer to collected data of the particular evidence type that is usable to verify whether an associated control is satisfied.

In some embodiments, the evidence collection module 106 collects and presents the evidence data that would support a finding of whether the corresponding control is satisfied. Alternatively and/or in addition, the evidence collection module 106 may verify whether the corresponding control is satisfied and present a conclusion or recommendation.

In some embodiments, the evidence collection module 106 may execute collection instructions associated with the control to make an Application Programming Interface (API) call to a customer environment 122 to collect the corresponding evidence data from the customer environment 122. An API is an interface that provides functions/methods of a first software module to a second software module. For example, a web API provided by the cloud service provider system 120 may define Hypertext Transfer Protocol (HTTP) request messages that may be submitted to interact with the customer environment 122. The web API may further define corresponding HTTP response messages that a user of the web API can expect in response to HTTP request messages.

The compliance server system 110 may store evidence data for one or more customers in an evidence database 116. For example, the evidence collection module 106 may store evidence data obtained from customer environments 122 and other sources in the evidence database 116.

### Collection Instructions

When the compliance server system 110 audits a customer for compliance with a standard, the evidence collection module 106 interacts with the cloud service provider system 120 to collect evidence data associated with a set of controls associated with the standard. In some embodiments, the evidence collection module 106 obtains the associated collection instructions that were generated by the standard processing module 102, which may be stored in the controls database 108. The evidence collection module 106 may execute the associated collection instructions to obtain evidence data usable to verify whether one or more customer environments 122 are compliant with the standard.

The collection instructions may include one or more parameters, arguments, pointers, references, executable code, calls, or other instructions that are usable by the evidence collection module 106 to collect the associated evidence data. When the evidence collection module 106 executes the collection instructions, the evidence collection module 106 executes code that is included in or generated based on the relevant collection instructions.

For example, when the collection instructions include executable code, the evidence collection module 106 may execute the collection instructions by executing the executable code to collect evidence data. As another example, when the collection instructions for a control includes an API call, the evidence collection module 106 may execute the collection instructions by making the API call to collect evidence data. As another example, when the collection instructions include an argument to a function or call, the evidence collection module 106 may execute the collection instructions by generating executable code including the function or call with the specified argument and executing the generated executable code to collect evidence data. As another example, when the collection instructions include a parameter, the evidence collection module 106 may execute the collection instructions by creating or modifying executable code based on the parameter and executing the executable code to collect evidence data. The evidence collection module may use additional files or other data to generate the executable code, such as template data, configuration data, and/or other data.

The evidence collection module 106 may collect evidence data from one or more customer environments 122 controlled by a customer when performing processes related to an audit of the customer. The evidence collection module 106 may directly communicate with the customer environment/s 122 at the cloud service provider system 120. In some embodiments, the customer grants the compliance server system 110 permissions to access one or more customer environment/s 122 so that the evidence collection module 106 can obtain the relevant evidence data. Alternatively and/or in addition, the evidence collection module 106 may audit the customer by interacting with the customer computer system 140 to cause the customer computer system 140 to communicate with the customer environment/s 122 at the cloud service provider system 120. For example, the evidence collection module 106 may provide a compliance system interface 112 to the customer computer system 140 that causes the customer computer system 140 to communicate with the customer environment 122 at cloud service provider system 120 to obtain evidence data.

### Example Data Model

In some embodiments, the standard processing module 102 processes one or more standards in accordance with a data model. The data model may include control data for one or more standards. In some embodiments, the control data includes collection instructions for obtaining evidence data from one or more customer environments 122. Example data models are described herein without limiting the organization of control data or other standard-related data to a particular example.

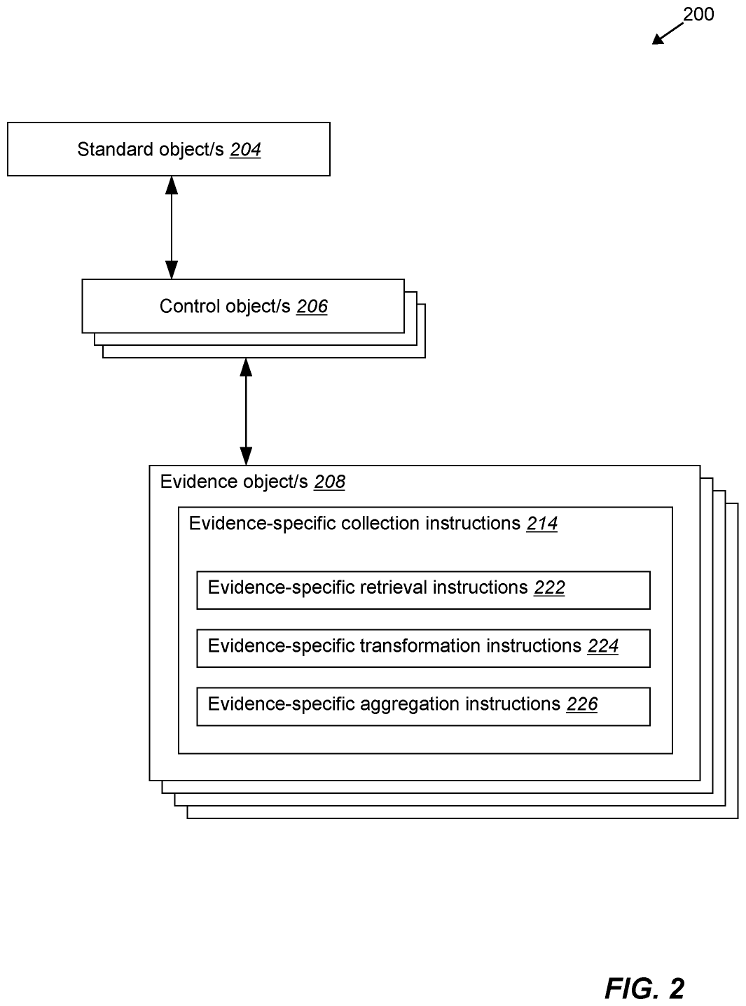

FIG. 2 illustrates instructions in a data model for automated evidence collection in an example embodiment. An example data model 200 includes one or more standard objects 204, one or more control objects 206, and one or more evidence objects 208. As used herein, the term “object” refers to any data structure that represents the indicated concept. A data model may be implemented in one or more embodiments that includes or omits one or more of the object types shown in the example data model 200. In some embodiments, a standard processing module (e.g. standard processing module 102) generates one or more objects 204-226 of the data model 200.

A standard may be associated with one or more controls relating to one or more aspects of the standard. When a standard is associated with a set of one or more controls, the corresponding standard object 204 is associated with one or more control objects 206 that represent controls in the set of one or more controls. As used herein, with respect to objects, the term “associated with” refers to a relationship that is represented in at least one of the data objects involved. For example, a standard object 204 may include relationship data identifying one or more control objects 206, and/or vice versa.

In some embodiments, a one-to-one relationship, one-to-many relationship, or many-to-many relationship may exist between standard objects 204 and control objects 206. That is, a particular standard object 204 may be associated with one or multiple control objects 206, and/or a particular control object 206 may be associated with one or multiple standard objects 204.

A control may be associated with one or more evidence types that are required in order to support a finding of whether the control is satisfied. One control may require evidence data of one or multiple evidence types to verify whether the control is satisfied. When a control is associated with one or more evidence types, the corresponding control object 206 is associated with one or more evidence objects 208 that represent the required evidence type/s.

In some embodiments, a one-to-one relationship, one-to-many relationship, or many-to-many relationship may exist between control objects 206 and evidence objects 208. That is, a particular control object 206 may be associated with one or multiple evidence objects 208, and/or a particular evidence object 208 may be associated with one or multiple control objects 206. An evidence object 208 that is “associated with” a particular control object 206 is also “associated with” any standard object 204 that is associated with the particular control object 206. The association exists whether or not the relationship to the standard object 204, or the control object 206 is stored within the evidence object 208.

In some embodiments, the data model 200 includes one or more types of collection instructions. For example, the data model 200 may include evidence-specific collection instructions 214. The evidence-specific collection instructions 214 may include one or more parameters, arguments, pointers, references, executable code, calls, or other instructions. When a compliance server system (e.g. compliance server system 110) executes the evidence-specific collection instructions 224 for an evidence object 208, the corresponding evidence data is collected. The corresponding evidence data relates to an aspect of a standard corresponding to a control object 206 that is associated with the evidence object 208. Alternatively and/or in addition, the data model 200 may include control-specific collection instructions belonging to an associated control object 206 and/or standard-specific collection instructions that belong to a corresponding standard object 204.

To audit an environment for compliance with a particular standard object 204, the compliance server system may execute collection instructions belonging to objects associated with the standard object 204. For example, the compliance server system may execute evidence-specific collection instructions 214 belonging to evidence objects 208 associated with the standard object 204, control-specific collection instructions belonging to control objects 206 associated with the standard object 204, and/or standard-specific collection instructions belonging to the standard object 204. Although one standard object 204 is illustrated, the data model 200 may accommodate multiple standard objects 204 corresponding to multiple standards.

Collection instructions, such as evidence-specific collection instructions 214, may include different types of collection instructions. For example, the evidence-specific collection instructions 214 of an evidence object 208 may include evidence-specific retrieval instructions 222, evidence-specific transformation instructions 224, evidence-specific aggregation instructions 226, and/or other types of evidence-specific collection instructions. Non-limiting examples of collection instruction types are described in greater detail hereinafter.

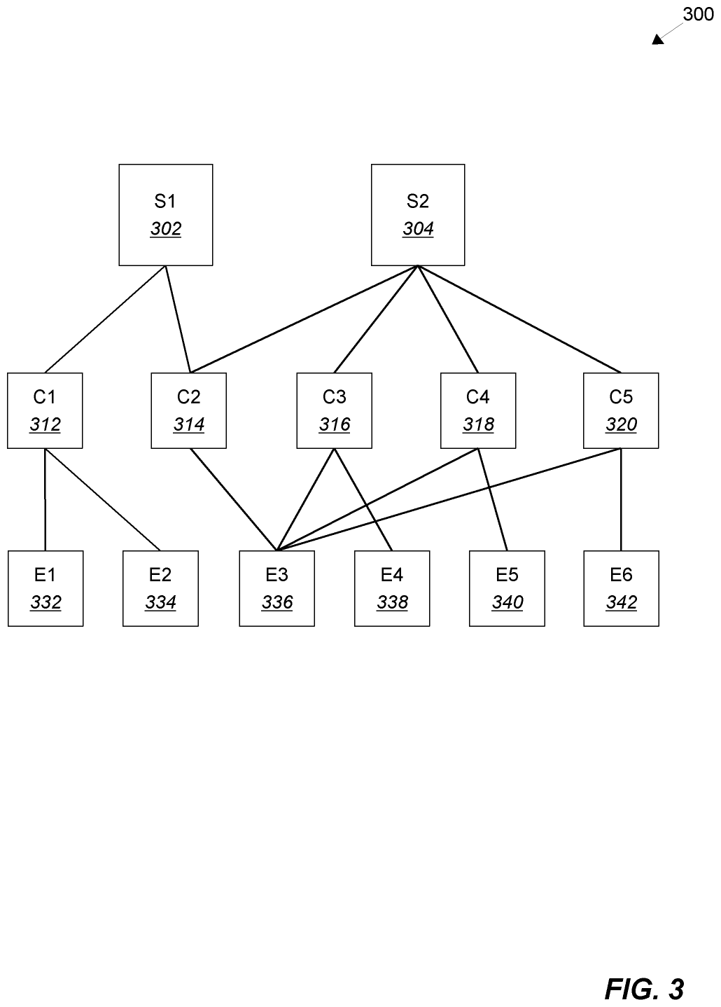

FIG. 3 illustrates relationships between standard objects, control objects, and evidence objects in a system for automated evidence collection in an example embodiment. In a control data set 300 stored in a controls database (e.g. controls database 108), example associations are shown between a set of one or more standard objects 302-304, a set of one or more control objects 312-320, and a set of one or more evidence objects 332-342. The same control object 314 associated with an aspect of a first standard and an aspect of a second standard may be associated with both a first standard object 302 and a second standard object 304.

An evidence object 336 may be associated with multiple control objects 314-320. This represents the case where the same evidence data is required by multiple controls. The corresponding evidence-specific collection instructions (e.g. evidence-specific collection instructions 214) may be executed one time to collect the corresponding evidence data that is required for all control objects 314-320 associated with the evidence object 336.

A control object 312 may be associated with multiple control objects 332-334. This represents the case where evidence data of multiple evidence types are required to satisfy a control.

### Example Instruction Execution Framework

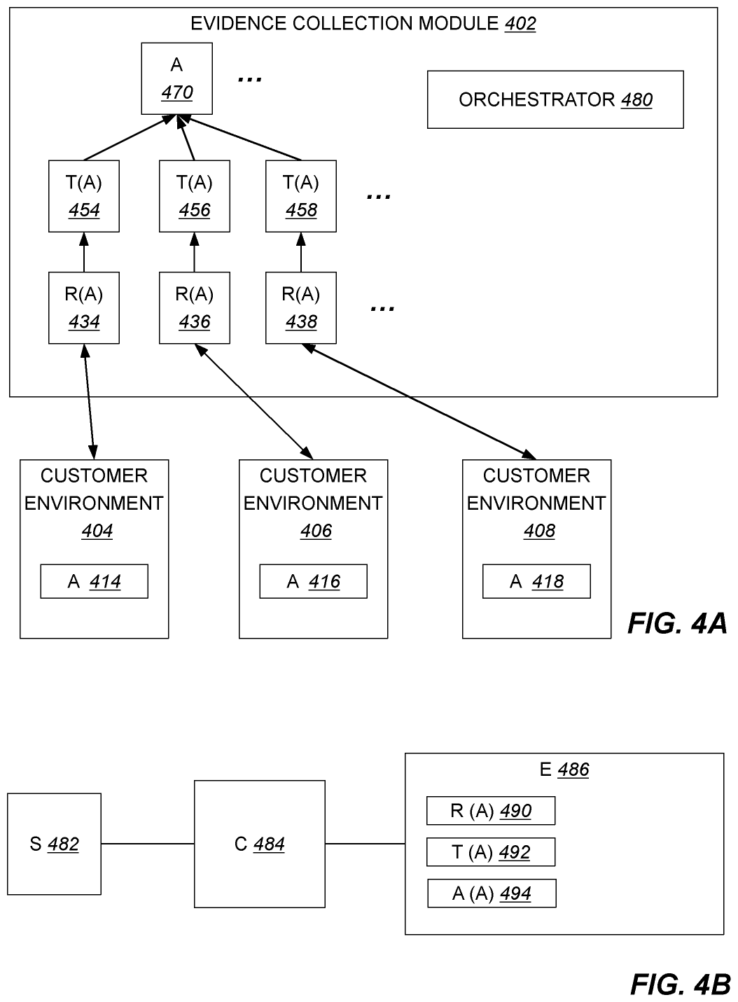

FIG. 4A illustrates an example evidence collection module executing collection instructions in an example embodiment. In the example embodiment, a customer has three customer environment instances 404-408 running at a cloud service provider system (e.g. cloud service provider system 120). The customer initiates an audit with respect to a standard. For example, the customer may submit an audit request to a compliance server system (e.g. compliance server system 110). The standard corresponds to a standard object (e.g. standard object 204) for which a data model (e.g. data model 200) was generated when the compliance server system processed the standard.

FIG. 4B illustrates example data objects belonging to the data model referenced in FIG. 4A, including a standard object 482, a control object 484, and an evidence object 486. In the data model, the standard object 482 is associated with a set of control objects that includes a control object 484, for which execution of collection instructions is illustrated in FIG. 4A. Control object 484 corresponds to an aspect of the standard represented by the standard object 482. The control object 484 is associated with evidence object 486. Evidence object 486 includes collection instructions 490-494 for evidence type A. Evidence data of evidence type A is necessary to support a finding of whether the control represented by the control object 484 is satisfied. For clarity in explanation, a single evidence object 486 and a single control object 484 are illustrated without limiting the number of objects and/or relationships between objects.

The evidence object 486 includes retrieval instructions 490 for evidence type A from a customer environment instance 404-408. For example, the retrieval instructions 490 may include one or more API calls to the customer environment instances 404-408 to obtain data in a raw format. In some embodiments, the customer has granted the compliance server system access to its customer environment instances 404-408 at the corresponding cloud service provider system.

The evidence collection module 402 may generate and execute instances of the retrieval instructions 490 specific to a particular customer environment instance to obtain evidence data of the respective evidence data types. For example, the evidence collection module 402 may generate and execute: a retrieval instructions instance 434 to retrieve evidence data 414 of evidence type A from customer environment instance 404, a retrieval instructions instance 436 to retrieve evidence data 416 of evidence type A from customer environment instance 406, and a retrieval instructions instance 438 to retrieve evidence data 418 of evidence type A from customer environment instance 408. In some embodiments, the retrieval instructions 490 are used as a template to generate the specific retrieval instructions instances 434-438.

The evidence object 486 includes transformation instructions 492 for transforming evidence data of evidence type A from an initial format into a desired format. The desired format may be a format required by a standard, an auditor, and/or another third party. The evidence collection module 402 may generate and execute transformation instructions instances 454-558 specific to a particular customer environment instance to transform evidence data received from the customer environment instances 404-408. For example, transformation instructions instance 454 may transform evidence data that retrieval instructions instance 434 obtained from customer environment instance 404; transformation instructions instance 456 may transform evidence data that retrieval instructions instance 436 obtained from customer environment instance 406; and transformation instructions instance 458 may transform evidence data that retrieval instructions instance 438 obtained from customer environment instance 408. In some embodiments, the transformation instructions 492 are used as a template to generate the specific transformation instructions instances 454-458.

The transformation instructions 492 may perform any type of processing on the evidence data retrieved by the retrieval instructions instances. For example, the transformation instructions 492 may transform the evidence data into a human-readable format. As another example, the retrieved evidence data may include a quantity of data from which the transformation instructions 492 calculate a required statistic. In some embodiments, the retrieved evidence data includes a quantity of data from which the transformation instructions 492 selects a required randomized sample.

The evidence object 486 includes aggregation instructions 494 for aggregating evidence data of evidence type A from multiple sources, such as but not limited to the three customer environment instances 404-408. The evidence collection module 402 may generate and execute an instance of the aggregation instructions 470 to aggregate transformed evidence data processed by the transformation instructions instances 454-458. In some embodiments, the aggregation instructions 494 are used as a template to generate one or more aggregation instructions instances 470. For example, if the customer executes multiple cloud environments each potentially having multiple instances, the evidence collection module 402 may generate aggregation instruction instances for each cloud environment.

While collection instructions instances 434-370 are shown for one evidence object 486 associated with a particular control object 484 and a particular standard object 482, the evidence collection module 402 may manage the execution of collection instructions instances for additional evidence objects, control objects, and/or standard objects related to an audit request. Furthermore, the evidence collection module 402 may handle a variety of environments related to an audit request.

In some embodiments, the evidence collection module 402 maintains a dependency graph or another structure to track dependencies between collection instructions instances 434-370. A dependency arises when one collection instructions instance requires an input generated by another collection instructions instance in order to successfully execute. For example, each transformation instructions instance 454-458 requires evidence data from a respective retrieval instructions instance 434-438 in order to transform the evidence data, and aggregation instructions instance 470 requires evidence data from each transformation instructions instance 454-458 in order to aggregate the evidence data.

The evidence collection module 402 may include an orchestrator process 480. The orchestrator process 480 controls execution of construction instructions instances based on the dependency graph. For example, the orchestrator process 480 may use the dependency graph to determine an order of execution of the construction instructions instances. The orchestrator 480 may be notified when a construction instructions instance completes execution in order to manage execution of the construction instruction instances in the dependency graph.

### Generating an Audit Result

A compliance server system (e.g. compliance server system 110) may generate an audit result after collecting evidence data. The audit result may be a collection of evidence data required to determine whether a customer is in compliance with a standard. In some embodiments, the compliance server system generates an audit result that includes an evaluation of the customer with respect to compliance with the standard. The evaluation may include an evaluation of the customer's compliance with one or more aspects of the standard corresponding to controls and/or control objects. Alternatively, the audit result may omit an evaluation of the customer and merely present the evidence data that would support a finding of whether aspects of the standard are satisfied.

In some embodiments, the control data generated by a standard processing module (e.g. standard processing module 102) includes reporting instructions associated with one or more controls. The reporting instructions may generate one or more notifications and/or documents that documents a party's compliance with the standard. The reporting instructions may include one or more parameters, arguments, pointers, references, executable code, calls, formats, or other instructions for presenting evidence data. Reporting instructions may be standard-specific, control-specific, and/or evidence-specific.

Reporting instructions may generate one or more types of reports. In some embodiments, the reporting instructions may generate a report for internal use in an organization. For example, the reporting instructions may include instructions for presenting evidence data in report used by a customer to manage operations. The reporting instructions may include instructions for presenting evidence data to a customer in an interface (e.g. compliance system interface 112). In some embodiments, the reporting instructions include one more notifications indicating potential events, tasks, triggers, or detected risk factors.

Alternatively and/or in addition, the reporting instructions may generate a report for an auditor, a client of the customer, or another party. For example, the reporting instructions may include instructions for presenting evidence data in an audit report. The evidence data may be stored as required by an auditor. For example, the auditor may require evidence data to be presented in a particular format. As another example, the auditor may require the storage of query information and/or time information associated with the evidence data. The reporting instructions may generate a report in a particular report format defined by a standard. In some embodiments, the reporting instructions generates a report that includes methodology information that is verifiable by an auditor.

### Evidence Collection Integrity

A compliance server system (e.g. compliance server system 110) may store integrity data about how evidence data is stored, when and by whom the evidence data was accessed, and/or whether any attempts were made to change the evidence data. In some embodiments, one or more measures are taken to ensure the integrity of evidence data after collection. For example, file integrity measures may be implemented, such as encryption, checksums, blockchain technology, and the like. In some embodiments, the evidence collection module maintains chain of custody information about the evidence data.

In some embodiments, the compliance server system generates additional data related to the authenticity and/or integrity of evidence data. For example, when an evidence collection module (e.g. evidence collection module 106) collects evidence data, the evidence collection module may collect integrity data indicating how the evidence data was collected, when the evidence data was collected, where the evidence data was collected (including but not limited to network information about one or more computers), and other information related to the integrity of the evidence data. The compliance server system may store the integrity data in association with the evidence data.

### Customer-Facing Portal

In some embodiments, a compliance server system (e.g. compliance server system 110) provides a customer-facing portal. For example, the compliance server system may provide a compliance system interface (e.g. compliance system interface 112) that allows a customer computer system (e.g. customer computer system 140) to interact with the compliance server system. In some embodiments, the compliance system interface is provided via a browser application executing at the customer computer system.

### Streamlined Evidence Data Management

A compliance server system (e.g. compliance server system 110) may fully automate evidence collection for one or more controls of a standard. In some embodiments, the compliance server system also streamlines the collection of evidence data for evidence types that are not fully automated. Evidence types that are not fully automated may still be represented in a data model (e.g. data model 200).

For example, one or more controls of an audit may require a copy of a customer's current information security policy. The compliance server system may generate a user interface (e.g. compliance system interface 112) that allows an authorized user to upload the customer's information security policy document. In some embodiments, an evidence object (e.g. evidence object 208) exists comprising collection instructions (e.g. evidence-specific collection instructions 214) that, when executed, receive and/or process an uploaded information security policy document, and store the information security policy document (e.g. in the evidence data database 116). The collection instructions may be executed one time to satisfy multiple controls that require the information security policy document.

The compliance server system may also streamline additional processes to provide a complete audit solution. For example, the compliance server system may provide a compliance system interface that allow one or more users to assign evidence collection tasks, communicate about tasks or evidence data, upload evidence data, review evidence data, annotate evidence data, configure evidence collection parameters, and/or otherwise manage evidence collection. In some embodiments, the compliance server system includes a calendar system, notification system, communication system, or other software-based organizational system to streamline evidence collection for an audit. Such organizational systems allow for the tracking of fully automated, partially automated, and/or human aspects of an audit. In some embodiments, the compliance server system integrates with one or more existing organizational systems, third-party software, and/or means of communication (e.g. email, SMS, MMS, and/or other means of communication) to allow the usage of these in the streamlining of an audit.

In some embodiments, the compliance server system implements one or more audit scoping features. For example, the compliance system interface may include options to apply a control to a subset of a customer's customer environments (e.g. customer environment 122) that the compliance server system has access to. For example, if a particular control related to data security only applies to systems that come into contact with payment data, an agent of the customer may indicate which customer environments are related to the particular control. As another example, a customer may wish to evaluate compliance with a subset of controls. Audit scoping may restrict the scope of evidence collection by factors such as but not limited to department, teams, computer systems, databases, data types, networks, time period, linked accounts, third-party vendors, and other factors.

In some embodiments, the compliance server system allows for the annotation of one or more aspects of an audit. For example, an authorized user may add a note and/or description to an uploaded document. As another example, the compliance server system may maintain a history of internal dialogue and/or workflow tasks within a customer organization. The annotation and/or history may include elements that are excluded from an audit result. Alternatively and/or in addition, the compliance server system may maintain annotation data that is intended to be included in an audit result.

### Auditor-Facing Portal

In some embodiments, a compliance server system (e.g. compliance server system 110) provides an auditor-facing portal. For example, the compliance server system may provide an auditor interface (e.g. compliance system interface 112) that allows an auditor or other third party to review evidence data showing compliance of the customer. The auditor-facing portal may show evidence data in a format required by an auditor, provide methodology information, provide data regarding the collection of the evidence data, provide data regarding the integrity of the evidence data after collection, and the like. In some embodiments, the auditor interface is provided via a browser application executing at an auditor's computer system.

### Example Processes

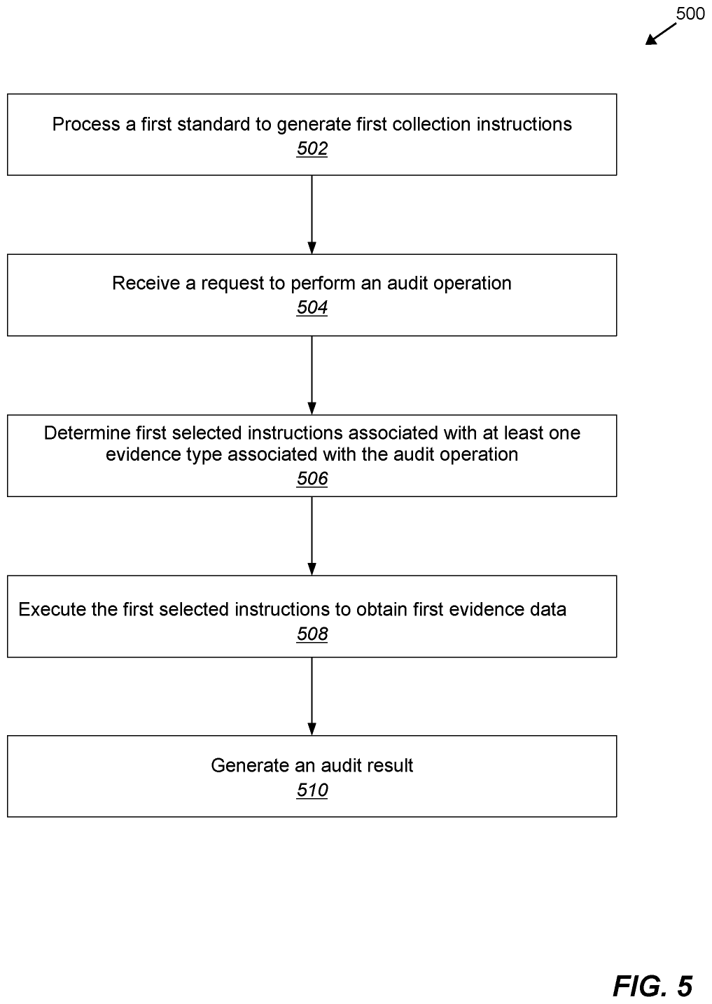

FIG. 5 is a flow diagram of a process for automated evidence collection in an example embodiment. Process 500 may be performed by one or more computing devices and/or processes thereof. For example, one or more blocks of process 500 may be performed by a computer system, such as but not limited to computer system 600. In one embodiment, one or more blocks of process 500 are performed by a compliance server system executing on a computing system, such as compliance server system 110. Process 500 will be described with respect to compliance server system 110, but is not limited to performance by compliance server system 110.

At block 502, the compliance server system 110 processes a first standard to generate first collection instructions. When executed, the first collection instructions obtain evidence data corresponding to a first plurality of evidence types from cloud environments deployed at a cloud service provider system.

At block 504, the compliance server system 110 receives a request to perform an audit operation. The audit operation is related to the first standard and a first cloud environment deployed at the cloud service provider system.

At block 506, the compliance server system 110 determines first selected instructions associated with at least one evidence type associated with the audit operation. The first selected instructions are selected from a set of collection instructions that include the first collection instructions.

At block 508, the compliance server system 110 executes the first selected instructions to obtain first evidence data on the first cloud environment from the cloud service provider system.

At block 510, the compliance server system 110 generates an audit result based on the first evidence data.

### Implementation Mechanisms—Hardware Overview

According to one embodiment, the techniques described herein are implemented by one or more special-purpose computing devices. The special-purpose computing devices may be hard-wired to perform one or more techniques described herein, including combinations thereof. Alternatively and/or in addition, the one or more special-purpose computing devices may include digital electronic devices such as one or more application-specific integrated circuits (ASICs) or field programmable gate arrays (FPGAs) that are persistently programmed to perform the techniques. Alternatively and/or in addition, the one or more special-purpose computing devices may include one or more general purpose hardware processors programmed to perform the techniques described herein pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices and/or any other device that incorporates hard-wired or program logic to implement the techniques.

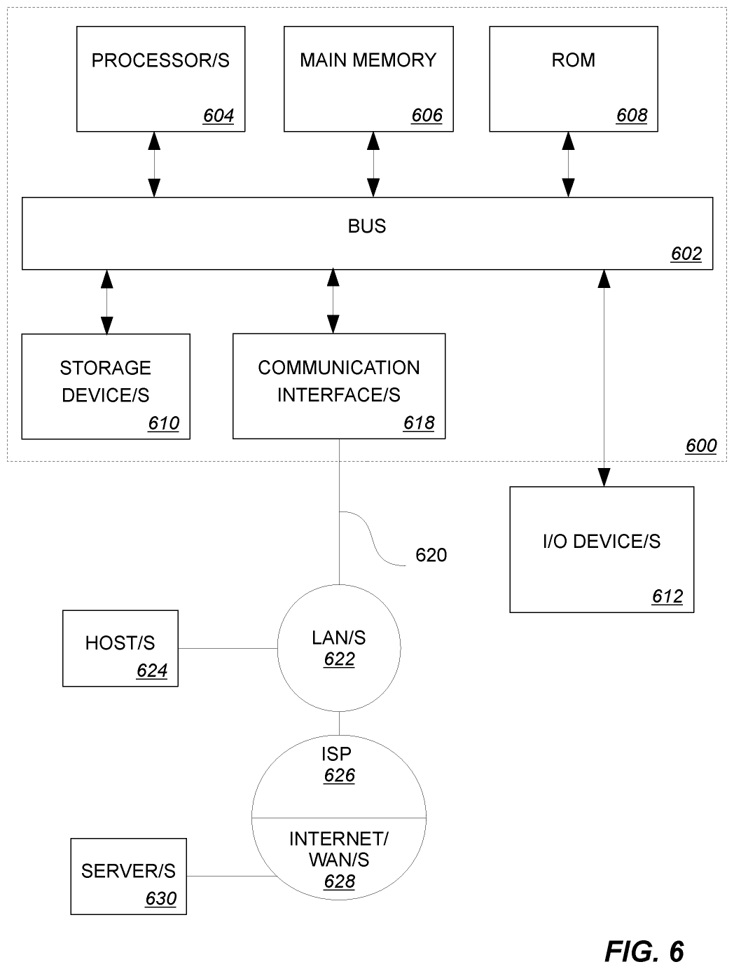

For example, FIG. 6 illustrates a computer system upon which an embodiment may be implemented. Computer system 600 includes a bus 602 or other communication mechanism for communicating information, and one or more hardware processors 604 coupled with bus 602 for processing information, such as basic computer instructions and data. Hardware processor/s 604 may include, for example, one or more general-purpose microprocessors, graphical processing units (GPUs), coprocessors, central processing units (CPUs), and/or other hardware processing units.

Computer system 600 also includes one or more units of main memory 606 coupled to bus 602, such as random access memory (RAM) or other dynamic storage, for storing information and instructions to be executed by processor/s 604. Main memory 606 may also be used for storing temporary variables or other intermediate information during execution of instructions to be executed by processor/s 604. Such instructions, when stored in non-transitory storage media accessible to processor/s 604, turn computer system 600 into a special-purpose machine that is customized to perform the operations specified in the instructions. In some embodiments, main memory 606 may include dynamic random-access memory (DRAM) (including but not limited to double data rate synchronous dynamic random-access memory (DDR SDRAM), thyristor random-access memory (T-RAM), zero-capacitor (Z-RAM™)) and/or non-volatile random-access memory (NVRAM).

Computer system 600 may further include one or more units of read-only memory (ROM) 608 or other static storage coupled to bus 602 for storing information and instructions for processor/s 604 that are either always static or static in normal operation but reprogrammable. For example, ROM 608 may store firmware for computer system 600. ROM 608 may include mask ROM (MROM) or other hard-wired ROM storing purely static information, programmable read-only memory (PROM), erasable programmable read-only memory (EPROM), electrically-erasable programmable read-only memory (EEPROM), another hardware memory chip or cartridge, or any other read-only memory unit.

One or more storage devices 610, such as a magnetic disk or optical disk, is provided and coupled to bus 602 for storing information and/or instructions. Storage device/s 610 may include non-volatile storage media such as, for example, read-only memory, optical disks (such as but not limited to compact discs (CDs), digital video discs (DVDs), Blu-ray discs (BDs)), magnetic disks, other magnetic media such as floppy disks and magnetic tape, solid state drives, flash memory, optical disks, one or more forms of non-volatile random access-memory (NVRAM), and/or other non-volatile storage media.

Computer system 600 may be coupled via bus 602 to one or more input/output (I/O) devices 612. For example, I/O device/s 612 may include one or more displays for displaying information to a computer user, such as a cathode ray tube (CRT) display, a Liquid Crystal Display (LCD) display, a Light-Emitting Diode (LED) display, a projector, and/or any other type of display.

I/O device/s 612 may also include one or more input devices, such as an alphanumeric keyboard and/or any other key pad device. The one or more input devices may also include one or more cursor control devices, such as a mouse, a trackball, a touch input device, or cursor direction keys for communicating direction information and command selections to processor 604 and for controlling cursor movement on another I/O device (e.g. a display). This input device typically has at degrees of freedom in two or more axes, (e.g. a first axis x, a second axis y, and optionally one or more additional axes z . . . ), that allows the device to specify positions in a plane. In some embodiments, the one or more I/O device/s 612 may include a device with combined I/O functionality, such as a touch-enabled display.

Other I/O device/s 612 may include a fingerprint reader, a scanner, an infrared (IR) device, an imaging device such as a camera or video recording device, a microphone, a speaker, an ambient light sensor, a pressure sensor, an accelerometer, a gyroscope, a magnetometer, another motion sensor, or any other device that can communicate signals, commands, and/or other information with processor/s 604 over bus 602.

Computer system 600 may implement the techniques described herein using customized hard-wired logic, one or more ASICs or FPGAs, firmware or program logic which, in combination with the computer system causes or programs, causes computer system 600 to be a special-purpose machine. According to one embodiment, the techniques herein are performed by computer system 600 in response to processor/s 604 executing one or more sequences of one or more instructions contained in main memory 606. Such instructions may be read into main memory 606 from another storage medium, such as one or more storage device/s 610. Execution of the sequences of instructions contained in main memory 606 causes processor/s 604 to perform the process steps described herein. In alternative embodiments, hard-wired circuitry may be used in place of or in combination with software instructions.

Computer system 600 also includes one or more communication interfaces 618 coupled to bus 602. Communication interface/s 618 provide two-way data communication over one or more physical or wireless network links 620 that are connected to a local network 622 and/or a wide area network (WAN), such as the Internet. For example, communication interface/s 618 may include an integrated services digital network (ISDN) card, cable modem, satellite modem, or a modem to provide a data communication connection to a corresponding type of telephone line. Alternatively and/or in addition, communication interface/s 618 may include one or more of: a local area network (LAN) device that provides a data communication connection to a compatible local network 622; a wireless local area network (WLAN) device that sends and receives wireless signals (such as electrical signals, electromagnetic signals, optical signals or other wireless signals representing various types of information) to a compatible LAN; a wireless wide area network (WWAN) device that sends and receives such signals over a cellular network access a wide area network (WAN, such as the Internet 628); and other networking devices that establish a communication channel between computer system 600 and one or more LANs 622 and/or WANs.

Network link/s 620 typically provides data communication through one or more networks to other data devices. For example, network link/s 620 may provide a connection through one or more local area networks 622 (LANs) to one or more host computers 624 or to data equipment operated by an Internet Service Provider (ISP) 626. ISP 626 in turn provides connectivity to one or more wide area networks 628, such as the Internet. LAN/s 622 and WAN/s 628 both use electrical, electromagnetic or optical signals that carry digital data streams. The signals through the various networks and the signals on network link/s 620 and through communication interface/s 618 are example forms of transmission media, or transitory media.

The term “storage media” as used herein refers to any non-transitory media that stores data and/or instructions that cause a machine to operate in a specific fashion. Such storage media may include volatile and/or non-volatile media. Storage media is distinct from but may be used in conjunction with transmission media. Transmission media participates in transferring information between storage media. For example, transmission media includes coaxial cables, copper wire and fiber optics, including traces and/or other physical electrically conductive components that comprise bus 602. Transmission media can also take the form of acoustic or light waves, such as those generated during radio-wave and infra-red data communications.

Various forms of media may be involved in carrying one or more sequences of one or more instructions to processor 604 for execution. For example, the instructions may initially be carried on a magnetic disk or solid state drive of a remote computer. The remote computer can load the instructions into its main memory 606 and send the instructions over a telecommunications line using a modem. A modem local to computer system 600 can receive the data on the telephone line and use an infra-red transmitter to convert the data to an infra-red signal. An infra-red detector can receive the data carried in the infra-red signal and appropriate circuitry can place the data on bus 602. Bus 602 carries the data to main memory 606, from which processor 604 retrieves and executes the instructions. The instructions received by main memory 606 may optionally be stored on storage device 610 either before or after execution by processor 604.

Computer system 600 can send messages and receive data, including program code, through the network(s), network link 620 and communication interface 618. In the Internet example, one or more servers 630 might transmit signals corresponding to data or instructions requested for an application program executed by the computer system 600 through the Internet 628, ISP 626, local network 622 and a communication interface 618. The received signals may include instructions and/or information for execution and/or processing by processor/s 604. Processor/s 604 may execute and/or process the instructions and/or information upon receiving the signals by accessing main memory 606, or at a later time by storing them and then accessing them from storage device/s 610.

### OTHER ASPECTS OF DISCLOSURE

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
processing a first standard to generate first collection instructions that, when executed, obtain evidence data corresponding to a first plurality of evidence types from cloud environments deployed at a cloud service provider system;
receiving a request to perform an audit operation, related to the first standard and a first cloud environment deployed at the cloud service provider system;
determining first selected instructions, of a set of collection instructions comprising the first collection instructions, that are associated with at least one evidence type associated with the audit operation;
executing the first selected instructions to obtain first evidence data on the first cloud environment from the cloud service provider system;
generating an audit result based on the first evidence data;
wherein the method is performed on a computer system comprising one or more processors.

2. The method of claim 1, wherein the request is generated when an entity that controls the first cloud environment initiates an audit to determine whether the entity satisfies the first standard.

3. The method of claim 1, further comprising:
providing a customer interface to a customer computer system, wherein the request to perform the audit operation is generated using the customer interface;
displaying the audit result in the customer interface.

4. The method of claim 1, further comprising:
processing a second standard to generate second collection instructions that, when executed, obtain evidence data corresponding to a second plurality of evidence types from cloud environments deployed at a cloud service provider system;
wherein the set of collection instructions comprises the second collection instructions.

5. The method of claim 4, further comprising:
receiving a second request to perform a second audit operation, related to the second standard and a second cloud environment deployed at the cloud service provider system;
determining second selected instructions, of the set of collection instructions, that are associated with at least one evidence type associated with the second audit operation;
executing the second selected instructions to obtain second evidence data on the second cloud environment from the cloud service provider system;
generating a second audit result based on the second evidence data.

6. The method of claim 1:
wherein processing the first standard further comprises generating third collection instructions that, when executed, obtain evidence data corresponding to the first plurality of evidence types from cloud environments deployed at a second cloud service provider system;
wherein the set of collection instructions comprises the third collection instructions.

7. The method of claim 6, further comprising:
receiving a third request to perform a third audit operation, related to the first standard and a third cloud environment deployed at the second cloud service provider system;
determining third selected instructions, of the set of collection instructions, that are associated with at least one evidence type associated with the third audit operation;
executing the third selected instructions to obtain third evidence data on the third cloud environment from the second cloud service provider system;
generating an audit result a third audit result based on the third evidence data.

8. The method of claim 1:
wherein the first collection instructions includes an API call to the cloud service provider system to collect evidence data of at least one evidence type;
wherein executing the first selected instructions includes executing the API call.

9. The method of claim 1, further comprising:
maintaining a database for a plurality of processed standards comprising the first standard;
wherein the database comprises a plurality of control objects associated with the plurality of standards and a plurality of evidence objects associated with the plurality of control objects.

10. The method of claim 1, further comprising:
generating an auditor interface for presenting the audit result and at least a portion of the first evidence data;
providing the auditor interface to an auditing party.

11. A computer system comprising:
one or more hardware processors;
at least one memory coupled to the one or more hardware processors and storing one or more instructions which, when executed by the one or more hardware processors, cause the one or more hardware processors to:
process a first standard to generate first collection instructions that, when executed, obtain evidence data corresponding to a first plurality of evidence types from cloud environments deployed at a cloud service provider system;
receive a request to perform an audit operation, related to the first standard and a first cloud environment deployed at the cloud service provider system;
determine first selected instructions, of a set of collection instructions comprising the first collection instructions, that are associated with at least one evidence type associated with the audit operation;
execute the first selected instructions to obtain first evidence data on the first cloud environment from the cloud service provider system;
generate an audit result based on the first evidence data.

12. The computer system of claim 11, wherein the request is generated when an entity that controls the first cloud environment initiates an audit to determine whether the entity satisfies the first standard.

13. The computer system of claim 11, wherein the one or more instructions, when executed by the one or more hardware processors, cause the one or more hardware processors to:
provide a customer interface to a customer computer system, wherein the request to perform the audit operation is generated using the customer interface;
display the audit result in the customer interface.

14. The computer system of claim 11, wherein the one or more instructions, when executed by the one or more hardware processors, cause the one or more hardware processors to:
process a second standard to generate second collection instructions that, when executed, obtain evidence data corresponding to a second plurality of evidence types from cloud environments deployed at a cloud service provider system;
wherein the set of collection instructions comprises the second collection instructions.

15. The computer system of claim 14, wherein the one or more instructions, when executed by the one or more hardware processors, cause the one or more hardware processors to:
receive a second request to perform a second audit operation, related to the second standard and a second cloud environment deployed at the cloud service provider system;
determine second selected instructions, of the set of collection instructions, that are associated with at least one evidence type associated with the second audit operation;
execute the second selected instructions to obtain second evidence data on the second cloud environment from the cloud service provider system;
generate a second audit result based on the second evidence data.

16. The computer system of claim 11:
wherein processing the first standard further comprises generating third collection instructions that, when executed, obtain evidence data corresponding to the first plurality of evidence types from cloud environments deployed at a second cloud service provider system;
wherein the set of collection instructions comprises the third collection instructions.

17. The computer system of claim 16, wherein the one or more instructions, when executed by the one or more hardware processors, cause the one or more hardware processors to:
receive a third request to perform a third audit operation, related to the first standard and a third cloud environment deployed at the second cloud service provider system;
determine third selected instructions, of the set of collection instructions, that are associated with at least one evidence type associated with the third audit operation;
execute the third selected instructions to obtain third evidence data on the third cloud environment from the second cloud service provider system;
generate a third audit result based on the third evidence data.

18. The computer system of claim 11:
wherein the first collection instructions includes an API call to the cloud service provider system to collect evidence data of at least one evidence type;
wherein executing the first selected instructions includes executing the API call.

19. The computer system of claim 11, wherein the one or more instructions, when executed by the one or more hardware processors, cause the one or more hardware processors to:
maintain a database for a plurality of processed standards comprising the first standard;
wherein the database comprises a plurality of control objects associated with the plurality of standards and a plurality of evidence objects associated with the plurality of control objects.

20. The computer system of claim 11, wherein the one or more instructions, when executed by the one or more hardware processors, cause the one or more hardware processors to:
generate an auditor interface for presenting the audit result and at least a portion of the first evidence data;
provide the auditor interface to an auditing party.
